(19) United States
(12) Patent Application Publication
(10) Pub. No.: US 2016/0053881 A1
(43) Pub. Date: Feb. 25, 2016

(54) DIVIDED TOOTHED WHEEL

(71) Applicant: GKN SINTER METAL HOLDING GMBH, Radevormwald (DE)

(72) Inventors: Andreas Zeller, Gründau (DE); Konstantin Reich, Wertheim (DE); Thomas Schupp, Scheuerfeld (DE)

(21) Appl. No.: 14/655,498

(22) PCT Filed: Dec. 20, 2013
(86) PCT No.: PCT/EP2013/003897

§ 371 Date: Oct. 6, 2015

(30) Foreign Application Priority Data
Dec. 28, 2012 (DE) 10 2012 025 210.2

(51) Int. Cl. F16H 55/18

(52) U.S. Cl. CPC F16H 55/18

(57) ABSTRACT

The invention relates to a toothed wheel that has a function for compensating tooth flank play in a meshing engagement with a second toothed wheel, using a divided toothing, said toothed wheel having at least one split along which a first toothed wheel half comprising a first section of the divided toothing and a second toothed wheel half comprising a second section of the divided toothing are arranged so as to be able to rotate relative to one another, the toothed wheel halves being arrested relative to one another by means of an anti-rotation system which, when activated, prevents mutual rotation of the toothed wheel halves. When said anti-rotation system is activated, the first and second sections of the divided toothing at least approximately engage with one another in a flush manner whereas, when the anti-rotation system is not activated, said first and second sections of the divided toothing are arranged to be offset to one another, both sections being tensioned relative to one another by means of a resilient element, and the inactive anti-rotation system remaining in the toothed wheel while said wheel is in operation. The invention also relates to a method for installing a divided toothed wheel.

The present invention relates to a toothed wheel having a compensating function for compensating, by use of a divided toothing, tooth flank play while in meshing engagement with a second toothed wheel.

Pairings of toothed wheels are often calculated on a theoretical basis and will then, in this theoretical design, have no play relative to each other. In practice, by contrast, due to tolerance fields caused by the production process, play will be generated between meshing toothings of toothed wheels. Additional factors enhancing such a play may be added because of installation inaccuracies of the toothed wheels on their respective shafts, propagation of installation errors and tolerance ranges of other components coupled to the toothed wheels. Such factors can be e.g. axis angle errors or also distance tolerances. A further influential factor with respect to the play between meshing flanks of toothed wheels is caused by varying operating temperatures: as a result of thermal expansion, particularly different thermal expansion coefficients of different materials, distances may change. Such cases relate to expansion within the mutually meshing toothed wheels but also e.g. a changed position of the toothed wheel support caused by thermal expansion. Thus, on the one hand, meshing wheels should have a play so as to compensate for such influences. On the other hand, play between meshing flanks will generate noise, e.g. in case of a change of flanks or in case of operation with a moment of rotation that cannot be transmitted in a uniform, constant manner.

To handle the above mentioned exemplary influential factors, toothed wheels are known which comprise a divided toothing. Such toothed wheels are often referred to as a so-called zero-play toothed wheel or a “scissor gear”.

Thus, for instance, EP 2 161 478 B1 teaches a toothed wheel which is of a divided design. A first toothed wheel half and a second toothed wheel half are tensioned relative to each other by an intermediate omega spring. Thereby, in the state of meshing with a second toothed wheel, a toothed flank will be in abutment at all times. The two toothed wheel halves are axially secured relative to each other by a securing ring. WO 2011/160153 A1 in turn teaches a divided toothed wheel wherein an elastomeric component is arranged between the two toothed wheel halves. Said elastomeric component is adapted to tension the two toothed wheel halves relative to each other. To assemble the two toothed wheel halves, a fixing aid is used. CN 101915297 teaches a divided toothed wheel wherein a spring is used by which a first toothed wheel half together with a second toothed wheel half are subjected to tension. By means of a securing rod, both toothed wheel halves can be fixed in mutual alignment in regard to their respective partial toothing. If the toothed wheel is e.g. mounted in a transmission, the securing rod will be removed from the toothed wheel, and the spring can subject the two toothed wheel halves to tension, thus guaranteeing the abutment of at least one of the two toothed wheel halves on the opposite toothed wheel in the area of the meshing toothings of the transmission.

A disadvantage of such a fixation of the two toothed wheel halves resides in that, during installation, the securing rod has to be removed from the toothed wheel. If, in this situation, the securement rod should happen to fall into the transmission, the latter will possibly have to be disassembled so as to avoid that the securing rod might cause damage during the later operation of the transmission.

It is an object of the present invention to provide a toothed wheel wherein such a disadvantage is avoided.

The above object is achieved by a toothed wheel comprising the features defined in claim 1 and by a method for installation of a divided toothed wheel comprising the features defined in claim 10. Advantageous further embodiments and features are evident in greater detail from the respective subclaims as well as from the following description and the Figures. However, the proposed new claims represent only a first proposal for a formulation of the subject matter of the invention without intending to restrict this inventive subject matter. Instead, one or a plurality of features from the respective independent claims can be supplemented or even be replaced by one or a plurality of features from the disclosure.

There is proposed a toothed wheel having a compensating function for compensating, by use of a divided toothing, tooth flank play in a meshing engagement with a toothed wheel, said toothed wheel having at least one split along which a first toothed wheel half comprising a first section of the divided toothing and a second toothed wheel half comprising a second section of the divided toothing are arranged so as to be able to rotate relative to one another, the toothed wheel halves being locked relative to one another by means of an anti-rotation system which, when activated, prevents mutual rotation of the toothed wheel halves, wherein, when said anti-rotation system is activated, the first and second sections of the divided toothing are arranged relative to each other in an at least approximately flush manner whereas, when the anti-rotation system is not activated, said first and second sections of the divided toothing are arranged to be offset relative to one another, both sections being tensioned relative to one another by means of a resilient element, and the inactive anti-rotation system remaining in the toothed wheel while said wheel is in operation.

In contrast to the teaching known from the state of the art wherein a securement of the two toothed wheel halves is effected via the securing rod which, however, has to be removed from the toothed wheel, the continued presence of the non-active anti-rotation system in the toothed wheel has the effect that a loss of the anti-rotation system during installation of the toothed wheel is avoided. This makes it possible to avoid errors in the assembly process of e.g. transmissions or other components wherein such a toothed wheel is to be used.

Preferably, the compensation of the tooth flank play can be achieved exclusively through the effect of the resilient element and the resultant tensioning of the toothed wheel halves relative to each other. In this respect, use can be made of technical designs of the types described in the above outlined state of the art. However, it can also be provided that at least a part of the toothing comprises a coating. This coating can e.g. be removable. Such provisions can be gathered e.g. from WO 2002/48575 to which reference is made in this regard. It is also possible to provide a coating that will not be removed but instead will remain on the toothing. For this purpose, one can select e.g. an elastomeric rubber coating with sufficient wear resistance.

Preferably, the toothing of the divided toothed wheel consists of the toothing of the first section and the toothing of the second section. Further, it can be provided that the toothed wheel does not comprise exclusively a first a nd a second toothed wheel half. It can also be provided that the toothed wheel comprises e.g. a third toothed wheel part which e.g. again includes a portion of the divided toothing. It can further be provided that the toothed wheel is divided into more components than only the first and the second toothing half without the necessity to provide, for this reason, an additional section of the divided toothing apart from the first section and the second section of the divided toothing.

According to one embodiment, the resilient element, for its part, which in case of the non-activated anti-rotation system will effect the tensioning of the two sections, whereby the compensating function for compensating tooth flank play in a meshing engagement of the toothed wheel with a second toothed wheel will take place, can be a single element. According to a further embodiment, it is possible to provide a plurality of resilient elements therefor. Particularly, it is also possible to use differently designed resilient elements, particularly if different spring forces are used with differently acting moments. Preferably, for use as a resilient element, also technical designs known from the above state of the art can be provided; herewith, reference is made to these designs.

In an example of the use of a special resilient element, it is provided that, for instance, there will first be installed an annular spring or alternatively a torsional spring. The latter can extend e.g. one or a plurality of times around the axis of the toothed wheel. For instance, one end of the torsional spring can be supported at the first toothed wheel half while the other end of the torsional spring is supported on the second toothed wheel half. By way of alternative, e.g. if a second component is provided for the toothed wheel, support can also be provided on this component. It can be provided e.g. that the first toothed wheel half is supported relative to this—e.g. fixed—component by means of a resilient element while the second toothed wheel half is supported, via a second resilient element, likewise on this fixed component. As a result, also this arrangement will achieve the tensioning of the first and second sections of the divided toothing.

According to one embodiment, the resilient element can be a spring, for instance. This spring can have a constant spring constant. According to a further embodiment, it is provided e.g. that the spring has a non-linear force-displacement relationship. Preferably, the resilient element has a progressive behavior, which is to say that the spring force will increase over-proportionally along the path. Also some other design of the resilient element can have such properties. According to a further embodiment, for instance, it can be provided that the spring force decreases along the path. According to one embodiment, it is provided e.g. that the spring force decreases along the path in a linear fashion. According to a further embodiment, it is provided that the spring force again decreases along the path and, notably, is reduced in a non-linear fashion. A decrease of the force can be advantageous for effecting an initial harder absorption of variations of the moment of rotation towards a subsequent softer transition.

According to a further embodiment, in turn, it is provided that the resilient element has e.g. a linear resilient behavior along a first path but has a non-linear behavior along a second path. This makes it possible that, e.g. in case of a slow starting and a resultant less effective moment of rotation, the resilient element will have to be operative only in the linear range. If, however, e.g. in case of fast acceleration, a very high moment of rotation is transmitted very suddenly, the non-linear behavior of the resilient element will have a protective effect and will avoid an otherwise possible unbraked impact of tooth flanks of the meshing toothed wheels that could contribute to a considerable generation of noise. Herein, the spring force can increase or also decrease along the path, depending on the design of the resilient element.

According to one embodiment, it is provided that the resilient element is formed e.g. by means of an elastomeric material. Further, the resilient element can be a torsional spring or also a pressure spring and respectively a resilient element acting in a corresponding manner. Further, the resilient element can also be a damper. A damper in the sense of the invention is an element which is adapted to dampen the impact of a tooth flank onto another tooth flank of a meshing toothed wheel. In principle, this effect can be obtained by a correspondingly yielding elastic damper which will be compressed.

According to a further embodiment, in turn, it is provided that a plurality of resilient elements are used, e.g. at least one resilient element which has a uniform spring constant and thus a linear behavior. On the other hand, there is provided at least a second resilient element which has a non-linear and, with particular preference, a progressive spring behavior. For instance, it can also be provided to use at least two resilient elements with identical properties. For instance, the resilient elements are arranged at a mutual offset of 180° in the toothed wheel. If there are used three resilient elements, preferably with identical spring properties, these are preferably arranged at a respective offset of 120° relative to each other in the toothed wheel. In case of four resilient elements, preferably with identical spring characteristic, these are arranged at a respective offset of 90° relative to each other. This series N=1, 2, 3, 4 . . . , wherein N=number of resilient elements, is preferably continued in the same manner, which is to say that the resilient elements are preferably arranged in the toothed wheel while preferably being offset relative to each other by the same angular distance. According to a further embodiment, this is provided particularly also for the arrangement of different resilient elements with different spring properties. In this case, resilient element with identical spring properties are distributed in a uniform manner. However, it can also be provided that a plurality of resilient elements are arranged in the toothed wheel at different offsets relative to other.

Further, it is possible to form groups of resilient elements, with each group preferably comprising at least two resilient elements having different spring properties relative to each other. The number of the resilient elements is influenced inter alia e.g. by the available space of the toothed wheel. Further, the load conditions to be transmitted can be considered as relevant factors for the selection of the resilient elements, particularly e.g. experiences with respect to the load change situation and possible noises otherwise generated in such a situation in case of non-abutment of the meshing toothed wheels.

Further, when selecting the resilient elements, also the material used for the resilient elements, the type of the resilient elements, the force to be transmitted and respectively the opposite force, and the to-be-transmitted moment of rotation can be relevant. The same holds true for the material of the toothed wheel itself and the possibly resultant constructional freedom or restriction, particularly with respect to the support of the respective resilient element having a first and a second end. Apart from an arrangement of a plurality of resilient elements along an identical radius around an axis of rotation, it is also possible to arrange one or a plurality of resilient elements of different radii with or without mutual offset around the axis of rotation.

Hereunder, the anti-rotation system as well as different embodiments and aspects of the anti-rotation system will be explained.

The continued presence of the anti-rotation system in the toothed wheel also during operation makes it possible to install the fully assembled multi-part toothed wheel in the secured state. During assembly of the toothed wheel, also the anti-rotation system is preferably inserted. According to a further embodiment, the anti-rotation system will be partly inserted during assembly whereas another part of the anti-rotation system will be mounted subsequently. This can be performed e.g. by insertion into the toothed wheel. Further, it is possible to mount a part of the anti-rotation system onto the toothed wheel. For instance, the anti-rotation system can be of a separable type. Thus, for instance, one part can remain in the toothed wheel while another part can be removed from the toothed wheel.

It is provided e.g. that, with the anti-rotation system activated, the first and second sections of the divided toothing are in flush arrangement relative to each other, preferably completely. This makes it possible that the toothed wheel can be inserted without having regard to the otherwise existing offset of the first and second sections of the divided toothing relative to each other. According to a further embodiment, it is provided that a certain offset is possible. This offset can result e.g. from the production accuracy. According to a further embodiment, it is provided e.g. that an offset can be generated also by means of a coating on only one side of the toothing, e.g. on only one of the two sections. According to a still further embodiment, it is provided that the first and the second section of the divided toothing have a slight offset relative to each other. This offset, however, is smaller than the resultant offset of the first and the second section of the divided toothing in the non-activated state of the anti-rotation system. These different embodiments wherein a slight offset can be provided are to be understood in the context of the description of an approximately flush transition between the first and the second section.

Further, it is preferably provided that the mutual locking of the two toothed wheel halves is effected by means of an anti-rotation system which can be released without being destroyed. In this manner, it is avoided that e.g. material fragments are generated during installation of the toothed wheel and may possibly cause damage e.g. to a transmission.

Preferably, the anti-rotation system can be activated in a repeatedly. For this purpose, it is provided e.g. that the anti-rotation system comprises a first position and a second position, both of which preferably are an end position. While the first position has associated to it e.g. an activated anti-rotation system wherein the toothed wheel halves are locked, the second position is e.g. provided to the effect that the anti-rotation system is not activated but that, instead, the first and the second section of the divided toothing are tensioned toward each other by means of a resilient element. The first and second positions are preferably both arranged in the toothed wheel itself. It is particularly preferred that the anti-rotation system itself does not project beyond an outer surface of the toothed wheel. According to a further, different embodiment, in turn, it is provided that the anti-rotation system partially projects from a surface of the toothed wheel in only one of the two positions of the toothed wheel. This is preferred e.g. in cases where, after completed installation, a positional change of the anti-rotation system is to be performed, without a tool, by external activation, e.g. by manual activation. It is also possible to use a tool for changing the position, preferably a hand-held tool, e.g. pliers. Use can also be made of a tool for automated operation, and the positional change can also be generated by application of force. For instance, a projecting component can be pressed in, be pulled, be pivoted or be activated in another manner in a force- or form-locking manner from the outside.

A repeatability of the activation and respectively deactivation makes it possible e.g. that a toothed wheel that has been mounted e.g. once can also be dismounted again, then be returned into its mounted state and then be mounted newly again. By this process, it is rendered possible e.g. that, in case of disassembly of a transmission and replacement of a transmission wheel, other transmission wheels that are not involved in such repair work but are designed as divided toothed wheels can be inserted again, notably in a locked state in which they had been mounted also before. In this manner, it can be safeguarded that a toothed wheel, once it has been installed, can also be detached from the shaft and then be mounted onto the same or onto another shaft, particularly a replacement shaft, and be returned to its installation position, while the toothed wheel halves are locked relative to each other.

There can also be provided a further locking of the two toothed wheel halves, notably after the two toothed wheel halves have been tensioned. By the locking effected in the tensioned condition, the divided toothed wheel can be removed from the shaft without the toothed wheel halves being still able to rotate relative to each other. Said further locking can be performed e.g. by the anti-rotation system. However, it is also possible to provide a locking component in addition to the anti-rotation system that will be functional to this effect.

Apart from an embodiment wherein a first and a second position, preferably each as an end position, are provided, it can also be envisioned that at least one further position of the anti-rotation system is possible, e.g. as an intermediate position. For instance, this intermediate position can effect the locking of the toothed wheel halves after the tensioning has been performed.

According to one embodiment, a single anti-rotation system is provided in the toothed wheel. According to a further embodiment, two or more anti-rotation systems are provided. For instance, it can be provided that two or more anti-rotation systems are coupled to each other. Thus, there can be provided e.g. a common activation and also deactivation.

The anti-rotation system is e.g. component arranged in the toothed wheel which in a first position will block a rotation of the toothed wheel halves relative to each other and in a second position allows for mutual rotation, wherein the component is subjected to tension at least in the second position. The tension can e.g. be constant during operation. However, it can also change. Also the reason for the generation of the tension can vary. According to one embodiment, for instance, it is provided that the anti-rotation system and the resilient element are formed as one component. In this embodiment, it is e.g. provided that the tension is generated by the resilient element itself. According to a further embodiment, it is provided that the component can be subjected to tension by another element which likewise has e.g. resilient properties.

According to a further embodiment, it is provided that only one component exists which allows for fixation of the two toothed wheel halves relative to each other in a direct or indirect manner, even if a plurality of resilient elements are provided. Thus, according to one embodiment, it can be provided that only one or two resilient elements are designed an anti-rotation system while other resilient elements are used exclusively for compensating the tooth flank play in a meshing engagement with the second toothed wheel.

According to a further embodiment, it is e.g. provided that the component arranged in the toothed wheel as an anti-rotation system is subjected to tension by having been moved from a first to a second position. For instance, it can be provided that the component in the toothed wheel is subjected to a lower tension in a first position than in the second position in which the anti-rotation system is not activated. For instance, in the first and the second position, there can also exist different reasons for the generation of tension. Further, it is possible to make use of different reasons for the generation of tension in one of the positions. For instance, it can be provided that, in the activated first position of the anti-rotation system and thus of the associated component, the latter is, on the one hand, subjected to tension by the resilient element. On the other hand, the component can be subjected to tension also by the surrounding material of the toothed wheel. Thus, for instance, also by use of a clearance fit and/or a press fit in which the component is e.g. arranged, a tension can be generated. For instance, in the second position of the component, a tension can be generated by providing that exclusively a press fit will be effective, wherein the component is to be shifted from the activated into the non-activated position in order to generate this tension. At the same time, this press fit can generate such a tension that the component will remain at its site during operation of the toothed wheel. Preferably, the component is secured in the non-activated position by the generated tension of the press fit so that, during operation, the non-activated anti-rotation system cannot accidentally get into an activated position.

According to a further embodiment, it is provided that a press fit will act e.g. only on a part of the component of the anti-rotation system. It can also be provided that the component can be transferred into a press fit via a play fit. Further, it can be provided e.g. that the component will be inserted into two press fits wherein, for instance, a first press fit is arranged in the first toothed wheel half and a second press fit is arranged in the second toothed wheel half.

According to a further embodiment, it is provided that the first and the second toothed wheel half each comprise respective guides adapted to be brought into mutual congruence, said guides having arranged in them a movable locking component acting as an anti-rotation system. According to one embodiment, it is provided e.g. that the locking component is movable along a guide. The locking component in turn is preferably arranged in an area of the guide which in normal operation of the toothed wheel, e.g. in a transmission, will not be reached.

For instance, the guide can be realized in form of a recess in the first as well as the second toothed wheel half. When these recesses are brought into congruence, it is possible e.g. to use the locking component at this site, thereby e.g. blocking a rotation of the first and second toothed wheel halves relative to each other. For instance, securement of the locking component can be realized by providing at least one press fit. According to a further embodiment, it is provided e.g. that the guide of the first toothed wheel half and the guide of the second toothed wheel half are brought into mutually flush alignment. If said flush alignment has been set with precision, the locking component can again be inserted at this site and will thus lock the first and second toothed wheel halves relative to each other. According to a still further embodiment, it is provided e.g. that a first guide in the first toothed wheel half and a second guide in the second toothed wheel have different designs. They can serve e.g. for defining a path along which the locking component will be guided. One of the two guides can then also comprise a stop realized e.g. by a stepped design. If, for instance, the stop component is moved beyond said step, the stop component can change its position not only along the circumference but also in axial direction.

The guide is preferably arranged in a radially surrounding manner around the axis of rotation of the toothed wheel. However, the guide can also be arranged at a radially varying distance from the axis of rotation of the toothed wheel. Particularly, the guide extends within the toothed wheel and is preferably covered by the respective toothed wheel halves. It can also be provided that the guide is arranged only within one toothed wheel half. Preferably, the guide is fully covered. Thereby, it is prevented e.g. that small particles from the external area of the toothed wheel can adhere and thus can add up to an agglomeration of such particles which would lead to a disturbance in the guide. According to a further embodiment, it is provided e.g. that the guide comprises at least one opening. Through an access passage to the outside via this opening, it is e.g. possible to actuate the locking component by use of a suitable tool. In this manner, the locking component can be brought into or out of a locking position from the outside.

Preferably, it is provided that a blockade of the movability between the first and the second toothed wheel half can be set e.g. also automatically, e.g. by rotating the toothed wheel halves relative to each other until the locking component is effective. If, however, the blockade is released, it preferably cannot be easily established again. It is preferred that this can be done only by intervention from the outside, e.g. by use of a tool especially provided for this purpose. In this manner, it is prevented that, during operation, the influential forces and moments could bring the two toothed wheel halves into such a constellation that the blockade of the movability of both toothed wheel halves relative to each other would be automatically blocked.

The locking component can be e.g. a bolt, a latch, a pin, a collar, a part of the resilient component and/or a locking assembly, each of them being preferably arranged within the toothed wheel. This enumeration is only of an exemplary nature without being complete.

According to one embodiment, it is e.g. provided that, for use of a resilient element, a leg spring is arranged in the toothed wheel, said leg spring serving as an anti-rotation system and as a component tensioning the two toothed wheel halves with each other. Thus, for instance, one end of the leg spring can have an angled shape. If the angled arm is used e.g. for engagement into two component parts of the toothed wheel, e.g. into the first and the second toothed wheel half, and respectively into one of the toothed wheel halves and an additional component, this will block the possibility of rotation e.g. of the two toothed wheel halves relative to each other. Thus, when the angled arm is removed again from one of the components, this will cause said blockade to be released. A mutual tensioning by the resilient element is maintained e.g. in that there exists a further coupling with that toothed wheel half and respectively the additional component that will be kept even if the e.g. one end is removed and the anti-rotation system will thus not be active anymore. By the coupling, the force transmission and thus the maintenance of a bias will continue to be safeguarded. Rotation of the first and second toothed wheel halves will then be possible again. According to a further embodiment, it is e.g. provided that, instead of complete removal, e.g. one end of the resilient element will be displaced within the toothed wheel half and respectively the additional component. While in a first position, e.g. of one end of the resilient element, this end will block the relative movement between the to-be-rotated components of the divided toothed wheel, a second position of the end will allow for such a relative movement.

Preferably, it is provided that the first and the second toothed wheel half comprise respective guides adapted to be brought into mutual congruence and that the anti-rotation system comprises an angled arm adapted to be inserted into both guides simultaneously and thereby to activate the anti-rotation system. For instance, the angled arm can be a part of the resilient element, and the two guides can have different geometries from each other. In such an arrangement, the geometry of one of the two guides can be designed to form a stop for the angled arm.

However, an angled arm or other shaped member that is guided along a guide and has a locking or arresting function can be provided not only in combination with a leg spring but also with another resilient element or with the anti-rotation system in a corresponding manner.

According to one embodiment, it is e.g. provided to use a coil spring having a first end and a second end. While the first end is fixedly connected to one of the two toothed wheel halves, the second end can be guided along a guide and be used for locking the two toothed wheel halves relative to each other. According to a further embodiment, it is provided that the second end is guided along a guide having at least a first plane and a second plane. Thus, for instance, the second end can be supported directly on the first plane and then, during movement along the guide, be supported on the second plane. The first plane is preferably offset relative to the second plane, with preference offset in height direction, and particularly is offset axially e.g. with respect to a shaft axis. The planes can extend e.g. in parallel to each other. Preferably, a height difference, preferably in form of a step, exists between the first and the second plane. The height difference, particularly the step, can serve as a stop. Thereby, e.g. the second end can be locked in a position whereby the two toothed wheel halves are either also locked relative to each other or are subjected to tension so as to be coupled to each other while being movable relative to each other for compensating the play.

According to a further preferred embodiment, it is provided that the anti-rotation system comprises a movable locking component, e.g. a displaceable locking bolt or locking pin. The displaceable locking pin is arranged within the toothed wheel. During assembly of the toothed wheel comprising the first and second toothed wheel halves, also the displaceable locking pin is inserted. Preferably with the aid of a suitable geometry of the first and respectively second toothed wheel half and of the locking pin, the locking pin secured against falling out. According to one embodiment, it is provided that the locking pin at its respective end face is at least partially covered toward the outside by the two end-side wheel halves. If the locking pin is provided to be displaceable in the axial direction in parallel to the axis of rotation of the toothed wheel, it is sufficient e.g. that a pressure can be exerted onto the locking pin from the outside, e.g. by means of a bolt, which pressure will cause a displacement of the locking pin. For this purpose, there is provided a e.g. corresponding opening in an outer surface of the toothed wheel.

According to one embodiment, the locking pin can be e.g. spring-loaded. This embodiment makes it possible that in case of a flush congruence of a first and a second guide which are each arranged in the to-be-locked components of the toothed wheel, an automatic stop is realized. According to a further embodiment, it is e.g. provided that the locking pin will lock the two components relative to each other until it will be pressed from the outside into a correspondingly dimensioned opening. In this opening, the locking pin will remain, e.g. by corresponding press fit and/or locking engagement and/or applied spring force. According to a further embodiment, it is e.g. provided that the locking pin can also be brought from the locking position into a release position, preferably from outside. This can be performed e.g. via a further opening in the toothed wheel.

However, the displaceability of the locking pin can be provided not only in an axial direction parallel to the axis of rotation of the toothed wheel. According to a further preferred embodiment, it is provided that the locking pin or a locking body can be arranged for displacement also in radial direction. According to a further embodiment, in turn, it is provided that a locking body can also be arranged within the toothed wheel for displacement in parallel to the circumference of the toothed wheel. Thus, the locking body can also have a different shape from that of a pin. Also other designs of the locking body, e.g. as a ball, a cylinder, a cone shape, a truncated cone and combinations of these, can be provided. It is also possible to provide a plurality of locking bodies. Further, different locking bodies can be used.

According to a further idea of the invention which can also be provided independently from the above described design of a toothed wheel having a compensating function for compensating, by use of a divided toothing, tooth flank play in a meshing engagement with a second toothed wheel, there is provided a method for installation of a divided toothed wheel as described hereunder. Preferably, this method for installation is performed in connection with the above described toothed wheel. The method provides that, for installation, a first and a second toothed wheel half of the divided toothed wheel will be locked relative to respective sections of a divided toothing in a manner preventing relative rotation, and that, after installation, a locking arrangement of the two toothed wheel halves will be released and the two toothed wheel halves will be left in a state of tension toward each other while being movable and, after release of the locking arrangement, a component effecting the locked state will be left to remain in the toothed wheel. This approach has the advantage that the per se divided toothed wheel can be treated in the same manner as an undivided toothed wheel. This will facilitate the installation. Further, during installation, it need not be observed that the possibly used locking component should not, as a loose part, happen to disturb the assembly process. Instead, no consideration need be given to this. Preferably, it is provided that the toothed wheel will be accessed from the outside and the component effecting the locking engagement will be displaced, thus releasing the locking engagement. For this purpose, e.g. a tool can be used. For instance, the tool can press onto the component effecting the locking engagement and thus cause a movement, preferably a displacement, of the component whereby the locking engagement will be released. Preferably, by use of the method, the component effecting the locking engagement will be brought not only into a release position. Instead, herein, the component can also be brought into a secured position provided within the toothed wheel. This secured position prevents that the component might accidentally become detached from the secured position and thus e.g. cause an unintended locking engagement.

According to one embodiment, it is e.g. provided that a screw driver or other longitudinal tool is used which will be inserted into an opening on a surface of the toothed wheel. Thereby, for instance, an axial pressure can be exerted onto the component so that the latter will be axially displaced. According to a further embodiment, it is e.g. provided that a displacement occurs along a circumferential direction of the toothed wheel. According to a still further embodiment, it is e.g. provided that a switch on the surface of the toothed wheel will be actuated whereby the locking component will be brought from the locking position into the release position.

Preferably, the material used for the toothed wheel is a metallic material. This can be e.g. a metal alloy, wherein the toothed wheel is manufactured from the solid material. Further, a plastic can be used for producing the material. The toothed wheel or also components thereof can be produced e.g. by an injection molding method. Further, individual components of the toothed wheel can be produced from different materials. Further, a sintering material can be used, preferably in case of special contours which are desired in one or both of the toothed wheel halves. Further, there can be used a powder injection molding, abbreviated PIM. In PIM, a metal provided with a binder—then abbreviated MIM for metal injection molding—or ceramic powder—then abbreviated CIM: ceramic injection molding—is processed in an injection molding process. The binder will be removed subsequently. In this manner, it is possible to produce complexly shaped toothed wheel halves in large numbers with very small tolerances.

For injection molding of metal and/or ceramic powder, use can be made of the most various sinterable powders with suitable particle sizes, such as e.g. oxide, silicate and nitride ceramics, carbides, translucent ceramics, metals and metal alloys inclusive of precious metals. These can be used as base materials. By suitable selection of a mixture of different powders of different materials, and/or of particle size distributions, the properties of the toothed wheel in regard to its later use can be influenced in a well-aimed manner. This also allows for adjustment of factors such as e.g. rigidity, viscosity, surface properties, corrosion resistance and others. In the production of powder injection molding masses, various binder systems can be used. Preferred use is made of binders which e.g. are water-soluble and biologically degradable, e.g. polyalcohols or polyvinyl alcohols. Depending on the binder used, different debinding processes can be used, preferably thermal, catalytic and/or solvent debinding, e.g. with water or acetone. The brown part and respectively white part can then be sintered.

The individual components of the toothed wheel, e.g. the first and/or second toothed wheel half or also the assembled toothed wheel, can be additionally treated in different manners. Thus, for instance, there can be at least partially provided a surface finish, e.g. sandblasting, slide finishing, polishing or lapping. It is also possible to provide a coating, e.g. for increasing the wear resistance. The coating can be applied e.g. by means of thinfilm technology, galvanizing or also lacquering. Apart therefrom, a thermal treatment can be provided, e.g. case-hardening, hot-isostatic pressing, or others. Also a machining treatment can be provided, e.g. turning, milling, drilling, grinding, rubbing, honing and/or tapping. Further, it is possible to achieve high precision by calibrating.

It is preferred to produce the individual components in such a manner that a post-treatment of individual components can be omitted. However, for reasons of precision, it may be necessary to provide e.g. a single treatment to be performed on the assembled toothed wheel.

Further, it is preferred that the assembled toothed wheel can be at least largely be produced automatically. For instance, the first and the second toothed wheel half can be produced by automatic manufacturing centers and then by assembled using an assembly line. In the process, the elements arranged in the toothed wheel, comprising one or a plurality of components, can again be inserted preferably in an automated manner, which holds true e.g. for the anti-rotation system as well as the resilient element or elements. According to one embodiment, it is provided that, for assembling the toothed wheel, the required components will be fabricated in advance and will be supplied from a storage site to the automatic assembly process. According to a further embodiment, it is provided that the components will be produced in parallel to the assembly process and will be directly supplied for assembly.

Further advantageous embodiments, features and modifications are evident from the Figures as detailed hereunder. These illustrate merely exemplary embodiments for clarification of the invention without, however, intending to restrict the same. Further, the features included in the individual embodiments are not restricted to the respective embodiments. Instead, one or a plurality of embodiments from one or a plurality of the Figures can be combined into further, additional embodiments. The same holds true also for the features and explanations rendered in the above description. The Figures show the following:

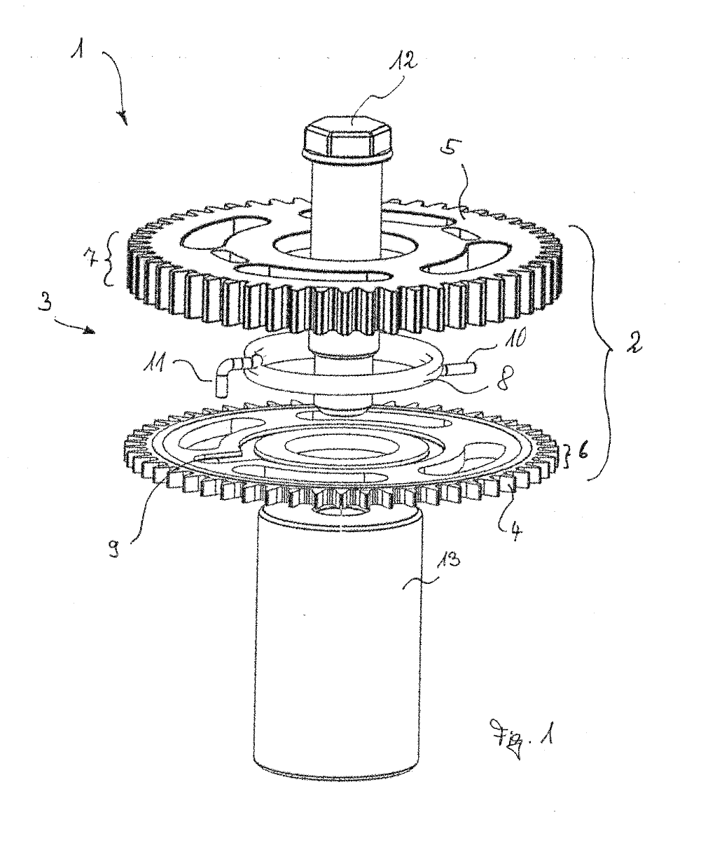

FIG. 1 is an exploded view of a first exemplary embodiment of a toothed wheel having a compensating function for compensating tooth flank play in a meshing engagement with a second toothed wheel,

FIG. 2 is a first top view of a first toothed wheel half of the toothed wheel of FIG. 1,

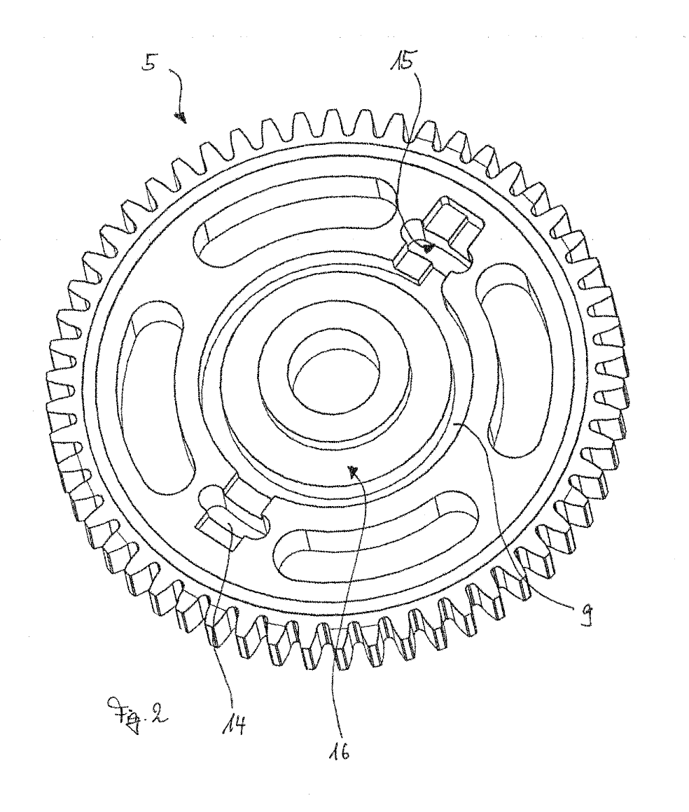

FIG. 3 is a sectional top view of a second toothed wheel half of the toothed wheel of FIG. 1,

FIG. 4 is a sectional view of the second toothed wheel half of FIG. 3,

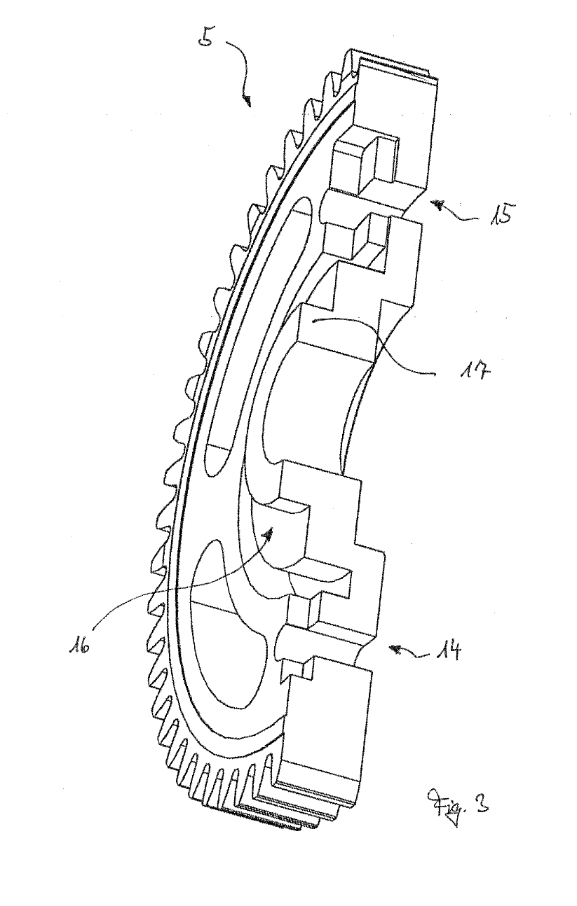

FIG. 5 is a view of an assembled toothed wheel comprising the individual components depicted in FIG. 1 to FIG. 4 in the secured position, i.e. with activated anti-rotation system,

FIG. 6 is a view of the second toothed wheel half according to FIG. 5 with an inserted resilient element,

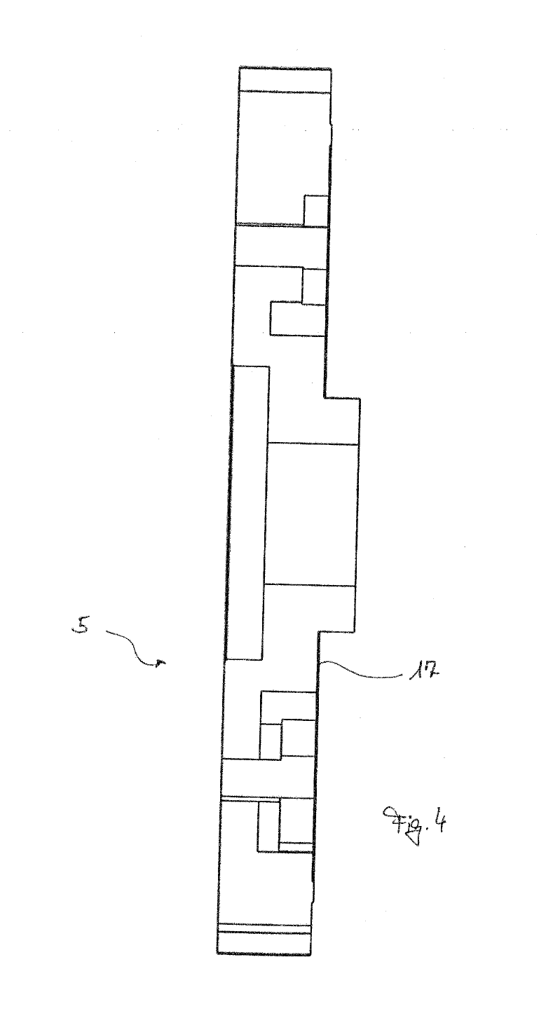

FIG. 7 is a partial view of the second toothed wheel half with an inserted resilient element, belonging to the assembled toothed wheel of FIG. 5,

FIG. 8 is a view of the toothed wheel of FIG. 5 with the anti-rotation system in the non-activated state and, as a result, the first and the second tooth half displaced toward each other,

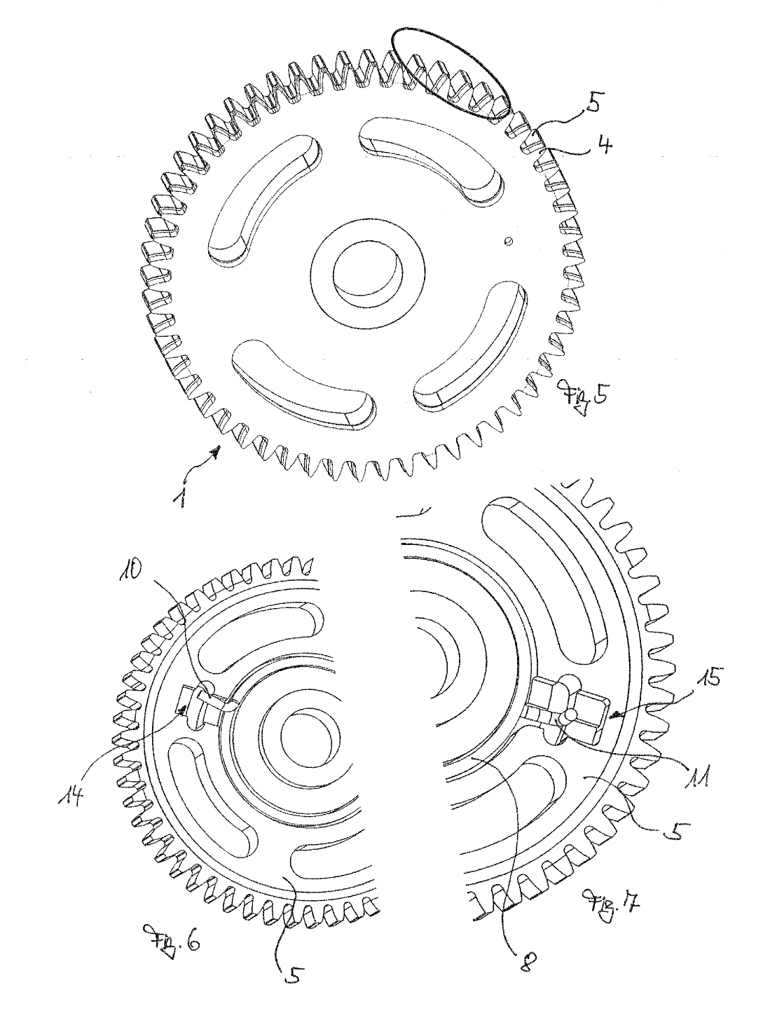

FIG. 9 a first partial view, seen from the inside, of the second toothed wheel half of FIG. 8 with inserted resilient element,

FIG. 10 a second partial view, seen from the inside, of the second toothed wheel half of FIG. 8 with inserted resilient element,

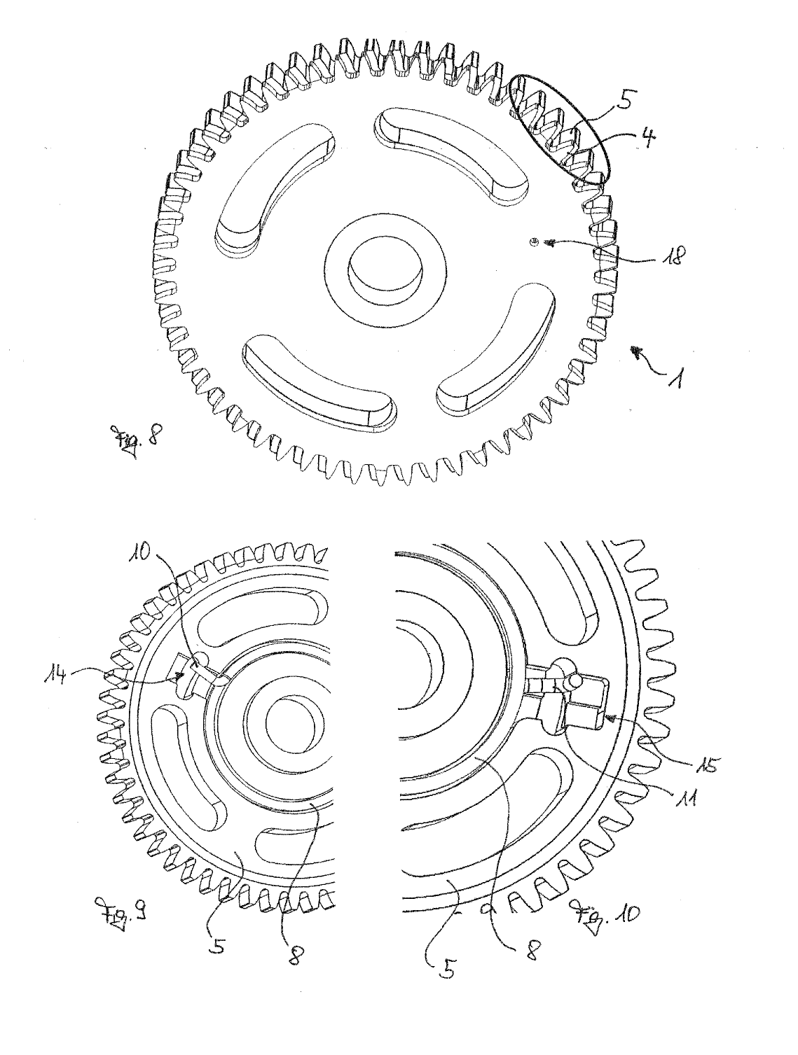

FIG. 11 a second embodiment of a second toothed wheel half with inserted resilient element in a first view,

FIG. 12 a top view of the embodiment of FIG. 11,

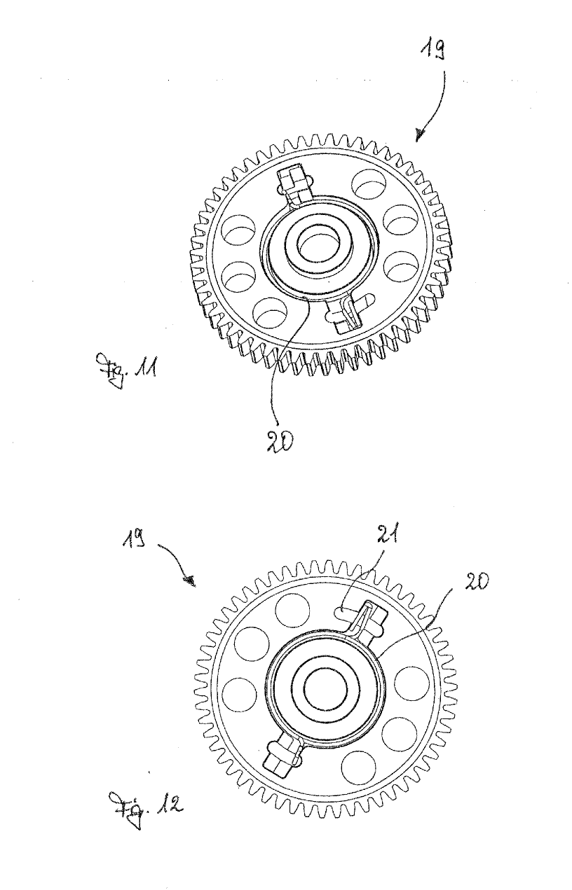

FIG. 13 an oblique view of the second toothed wheel half depicted in FIG. 11 and FIG. 12,

FIG. 14 an enlarged portion from FIG. 13,

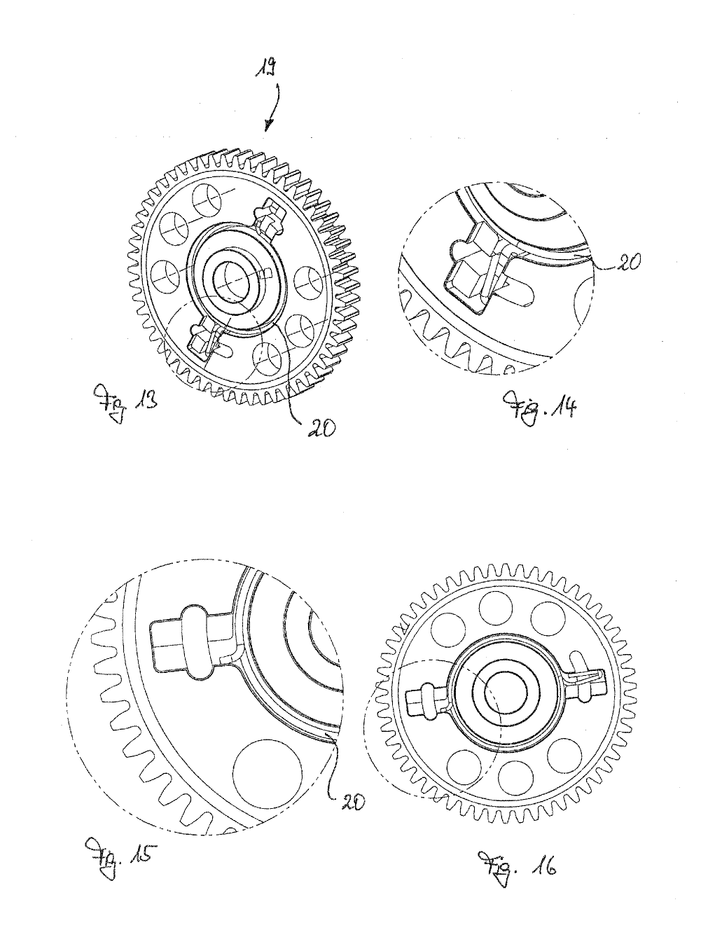

FIG. 15 and

FIG. 16 a top view of the second toothed wheel half depicted in FIG. 13 with an enlarged representation of the support of the resilient element,

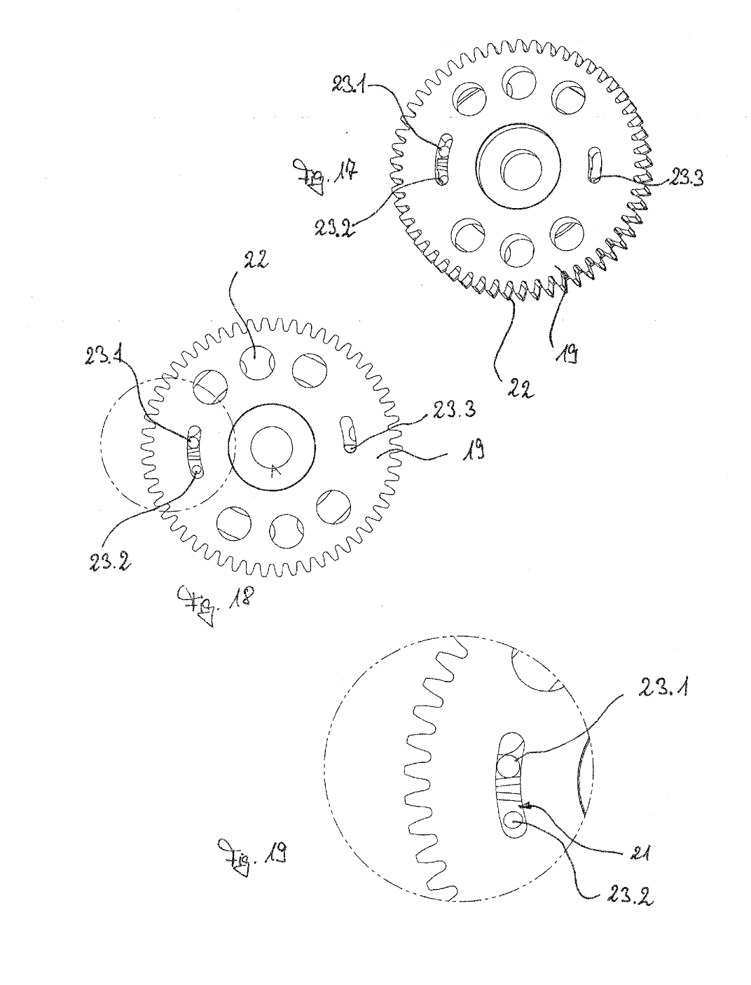

FIG. 17 an assembled toothed wheel with the constellation of a second toothed wheel half depicted in FIG. 11 to FIG. 16,

FIG. 18 a top view of the toothed wheel of FIG. 17,

FIG. 19 an enlarged partial view from FIG. 18,

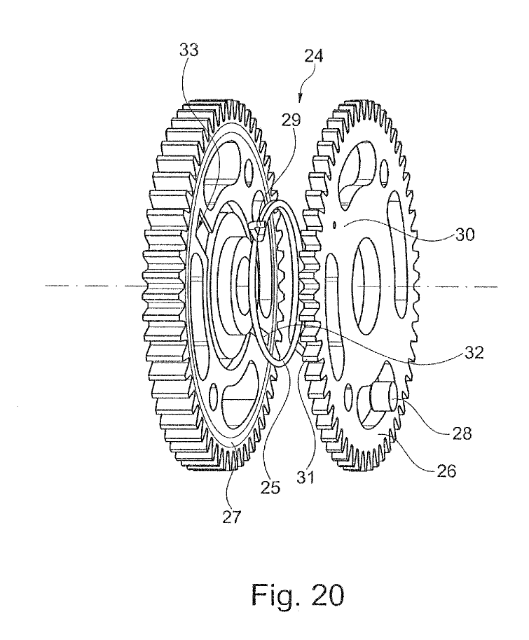

FIG. 20 a further embodiment of a proposed toothed wheel in exploded view,

FIG. 21 a sectional view of the assembled toothed wheel of FIG. 20 with activated anti-rotation system,

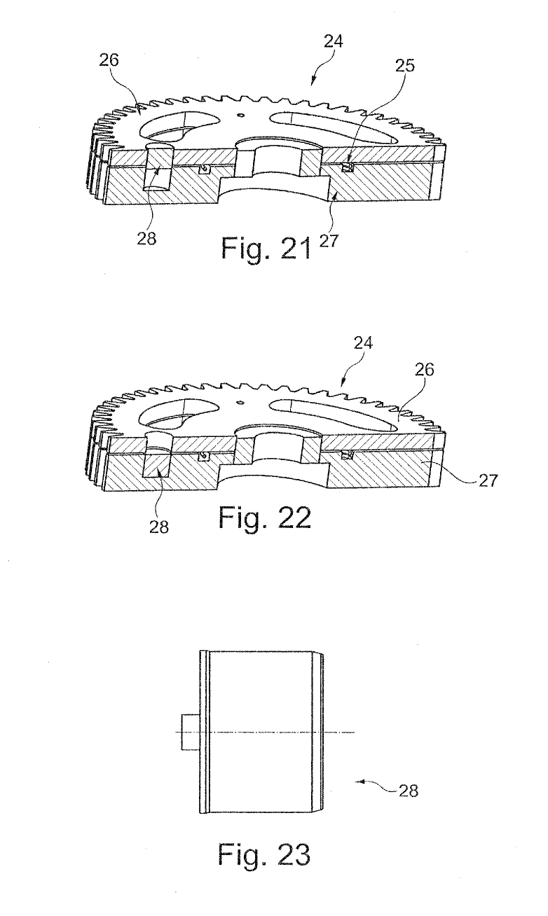

FIG. 22 the toothed wheel depicted in FIG. 20 and FIG. 21 with non-activated anti-rotation system,

FIG. 23 an exemplary embodiment of an anti-rotation system in the form of a displaceable locking pin as depicted in FIG. 21 and FIG. 22.

FIG. 1 shows a first toothed wheel 1 comprising a divided toothing 2 which herein is presented in exploded view. The toothed wheel 1 comprises a split 3. According to the herein illustrated design of the toothed wheel 1, said split 3 extends vertically to an axis of rotation of toothed wheel 1. However, the split 3 can also at least partially extend in a different manner, e.g. with an axial orientation. Thereby, the toothed wheel 1 is divided into a first toothed wheel half 4 and a second toothed wheel half 5. The first toothed wheel half 4 comprises a first section 6, and the second toothed wheel half 5 comprises a second section 7 of the toothing. Further, a resilient element 8 is arranged between the first toothed wheel half 4 and the second toothed wheel half 5. For placing the resilient element in the toothed wheel, a corresponding recess 9 is provided in at least one of the two toothed wheel halves 4,5. Preferably, said recess is provided in the wider second toothed wheel half 5. The latter preferably also comprises a wider toothing section. Further, said wider toothing section is preferably the one that largely performs a force and respectively moment transmission. It is also possible to provide a recess in both toothed wheel halves 4,5, as illustrated. A depth of the respective recess is preferably selected in dependence on the constructional height of the resilient element 8 used. In the present exploded view, there is illustrated the recess 9 provided in the first toothed wheel half 4 in an inner side thereof. According to this embodiment, the resilient element is designed as a torsional spring having a first end 10 and a second end 11. Herein, the second end 11 comprises an angled arm 12. In this embodiment, the angled arm 12 will be arranged in a corresponding geometry of the recess 9 of the first toothed wheel half 4. The torsional spring as the resilient element 8 preferably comprises one to three, optionally four or more windings. This is dependent particularly on the spring tension with which the two toothed wheel halves 4,5 shall be tensioned after release of a locking engagement. For instance, there can be provided a tension of one N/m. Preferably, this tension is in a range from 0.5 N/m to 2 N/m.

As further evident from FIG. 1, the first toothed wheel half 4 is thinner than the second toothed wheel half 5 particularly in the area of the divided toothing 2 with the first section. It is preferred that the second toothed wheel half is, on the whole, thicker than the first toothed wheel half 4. According to a preferred embodiment, it is provided that the first toothed wheel half 4 is not only thinner but, apart therefrom, that its toothing comprises thinner flanks in the first section 6 than the corresponding toothing of the second toothed wheel half 5 in the second section 7. This is illustrated in greater detail in the following Figures.

Securement of the individual components of toothed wheel 1 can be realized e.g. in the depicted manner by threaded engagement by use of a longitudinal bolt 12. There is provided a counterpart 13 to said bolt so that the toothed wheel 1 can be screwed into place and fastened by means of the longitudinal bolt 12. Also other types of securement are possible, e.g. by means of a securement ring. Said counterpart 13 is shown only in an exemplary manner. It is representative of merely one of a wide variety of possibilities of where and how the proposed toothed wheel 1 can be arranged and used.

As examples of possible applications, there may be mentioned any use of toothed wheels in engines, particularly internal combustion engines, but also in transmissions. Thus, for instance, an application is possible particularly in camshafts, crankshafts or also in household appliances. A preferred application is that in 3-cylinder engines. Due to the moments of rotation generated in a 3-cylinder engine and the variations of these moments, but also due to imbalance generated in a 3-cylinder engine, a larger noise development may be caused as compared to e.g. 4- or 6-cylinder engines. By use of the proposed toothed wheel, e.g. toothed wheel 1, it is rendered possible, particularly in such a 3-cylinder internal combustion engine, to reduce the noise development in a corresponding manner. Further, however, it is possible to use such a toothed wheel also in any other meshing toothed wheel connection, particularly if a noise development is to be avoided.

FIG. 2 is an oblique view of the second toothed wheel half 5 from FIG. 1 showing its inner side, in relation to an assembled toothed wheel. Also in this Figure, a recess 9 for the resilient element can be seen. Further provided are a first guide 14 and a second guide 15 which in cooperation with the resilient element will ensure the generating of the tension between the first toothed wheel half and the second toothed wheel half 5 when the anti-rotation system is not activated. The second guide 15 is particularly of a step-shaped design. This allows for an offset of a part of the resilient element, not illustrated here. It is thus rendered possible to use the resilient element e.g. as an anti-rotation system. Depending on the position where a part of the resilient element is arranged in the guide, the latter in this case being the second guide 15, the anti-rotation system will be in the activated or non-activated state.

In FIG. 2, there is further shown a guide and sliding area 16. In this guide and sliding area 16, the first and the second toothed wheel half are preferably in contact with other and can be rotated about each other there. According to one embodiment, the guide and sliding area 16 can be restricted exclusively—at least substantially exclusively—to the collar which is marked by the arrow. According to a further embodiment, it is provided that at least one further sliding area exists, e.g. in the immediate vicinity of the collar, particularly in abutment therewith. Further, it is of advantage if, between the toothed wheel halves, the actual contact area is kept small. This will avoid unnecessary friction and will also allow for a more sensitive behavior of the divided toothed wheel. It is preferred e.g. that one or both of the toothed wheel halves respectively comprise a minimally deepened portion on the mutually opposite sides so that a direct contact will be avoided. Said minimally deepened portion is preferably at least approximately full-faced. For instance, it can extend from the collar radially toward the outside until to an area close to the toothing.

FIG. 3 is an oblique sectional view of a second toothed wheel half 5. On the one hand, this view again shows the respective step-shaped design of the first guide 14 and the second guide 15. On the other hand, this oblique view also clearly depicts the design of a collar 17 which is also used for the guide and sliding area 16.

FIG. 4 shows the second toothed wheel half 5 from the preceding Figures in sectional view. This sectional view clearly depicts the position of the respective guides and an exemplary embodiment of the further geometries arranged in the second toothed wheel half 5. This view also includes a clearer representation of a raised portion 17 arranged in a circular shape around the axis of rotation on the inner periphery of the second toothed wheel half 5. Said raised portion makes it possible e.g. that a film of lubricating agent can be formed within the raised portion that will permanently guarantee the rotation between the two toothed wheel halves.

FIG. 5 shows the toothed wheel 1 of FIG. 1 in the assembled state. The first toothed wheel half 4 and the second toothed wheel half 5 are secured relative to each other. As can be seen in this Figure, the flanks of the toothing of the first toothed wheel half 4 are slimmer than the flanks of the toothing of the second toothed wheel half 5. This is represented with particular clarity in the area marked by a circle around it. The difference is particularly of such an extent that the toothing of the second toothed wheel half fully covers the toothing of the first toothed wheel half, particularly if—as illustrated—the anti-rotation system is active. However, the position of the two toothed wheel halves 4,5 and their toothing is still of such a nature that the configuration can still be considered as a flush transition from one toothing to the adjacent toothing.

FIG. 6 and FIG. 7 each are views onto the inner side of the second toothed wheel half 5. FIG. 6 herein shows the position of the resilient element 8 in the first guide 14 while FIG. 7 shows the position of the resilient element 8 in the second guide 15. Herein, there is illustrated the respective position in the locked state, i.e. with the anti-rotation system activated. In this state, the second end 11 with the angled arm is in abutment on a step of the second guide 15 wherein, in this embodiment, the second end 11 is arranged on a lower position of the step-like second guide 15. The first end 10, however, is in abutment on an edge or wall of the first guide 14. Preferably already in this situation, the resilient element 8 is under tension.

FIG. 8 shows the toothed wheel 1 from the previous Figures in the non-activated state of the anti-rotation system. Thereby, both toothed wheel halves 4,5 are tensioned relative to each other, preferably against each other, wherein both toothed wheel halves 4,5 are also arranged at an offset relative to each other. The offset is dependent on the direction of the tension of the resilient element. Also via the design and geometry of the displacement path made available, e.g. in the recess, influence can be taken on the offset, e.g. by use as a stop or by installing a stop. The offset is clearly visible especially in the area marked by a circle. This offset makes it possible to provide the compensating function for compensating tooth flank play in a meshing engagement with a second toothed wheel. As can further be gathered from FIG. 8, the anti-rotation system is still included in the toothed wheel 1. There is illustrated, by way of example, a small opening 18 in the outer surface of the first toothed wheel half 4. Through this opening 18, a tool can be inserted and, thereby, the second end 11 of the resilient element can be brought from a locking position in the guide into a release position. The resilient element acting as an anti-rotation system remains in the toothed wheel 1. The danger that the anti-rotation system could fall out or, when being removed, could accidentally fall into a casing, is eliminated. The illustrated opening merely represents an example with respect to its geometry and position. The opening for inserting the tool can be located at a different site of the toothed wheel half and can e.g. be one of said recesses themselves which extends all the way to the surface. For instance, the release from a locking arrangement can be performed with the aid of a tool which will be inserted into the recess, e.g. into the recess 15 in FIG. 2. Then, for instance, a pressure can be exerted onto the second end 11 of FIG. 1 that is arranged in this recess 15, which pressure will result in a displacement of the second end 11. Further, said opening can also be arranged on the second toothed wheel half. Further, the opening can be larger, have a longitudinal orientation or be designed in another manner. According to a further embodiment, it is e.g. provided that a displacement is performed from the outside, e.g. by use of a magnet.

According to a further embodiment, it is e.g. provided that the small opening 18 is used for allowing an end of the resilient element to be anchored in it. Thereby, the opening 18 will function as a follower for the first toothed wheel half 4. Further, thereby, the resilient element is preferably anchored in the toothed wheel half. Thus, for instance, the contour of the opening is adapted, preferably identically, to the contour of the end of the resilient element that is to be inserted. For instance, the resilient element can comprise a round spring steel wire engaging a round bore forming the opening 18. Preferably, the resilient element is made of spring steel wire. Said opening 18 may be provided but does not always absolutely have to be provided. Instead, it is also possible to provide a blind hole in the toothed wheel half, with the end of the resilient element inserted into it.

FIG. 9 and FIG. 10 in turn show the second toothed wheel half 5 with the resilient element 8 according to FIG. 8 and the non-activated anti-rotation system. FIG. 9 herein shows the position of the resilient element 8 in the first guide 14 while FIG. 10 shows the position of the resilient element 8 in the second guide 15. Herein, the respective position is depicted in the non-locked state, i.e. non-activated the anti-rotation system. In this arrangement, the second end 11 with the angled arm is not in abutment on a step of the second guide 15 anymore. Instead, said end has been shifted past this step and is now resting on the latter. Thus, in this embodiment, the second end 11 is arranged on an upper position of the step-like second guide 15. The first end 10, by contrast, continues to be in abutment on the same edge or wall of the first guide 14. The resilient element 8 is now able, while being under tension, to cause a relative movement between the first and second toothed wheel halves.

FIG. 11 shows a further embodiment of a second toothed wheel half 19 having a second resilient element 20. In this embodiment, as also in the previous one, of the second toothed wheel, the resilient element is substantially—preferably at least approximately completely and more preferably completely—arranged in the second toothed wheel half. For this reason, it is preferred that the second toothed wheel half at least in the area of the placement of the resilient element has a larger thickness than the first toothed wheel half. Preferably, the second toothed wheel half has a larger thickness also than the first toothed wheel half also in the area of the toothing. Preferably, only a portion of the resilient element, in this case an end of the illustrated leg spring, will act together with the first toothed wheel half to generate the tensioning. Thus, this end can at the same time also be used for the locking engagement, thereby forming the anti-rotation system. Also the second toothed wheel half 19 comprises guides in which the respective ends of the resilient element 20 are arranged. In this case, however, one end of the resilient element 20, formed as a leg spring, is additionally bent as a bending spring.

FIG. 12 shows the second toothed wheel half 19 of FIG. 11 in top view. From this view, the bent shape of the one end 21 is evident more clearly. On the one end, it can be seen in this top view that, in addition to the torsionally resilient moment support, there also exists a resilient support of the resilient element 20 that is added by the bent end element. Further, the top view clearly shows the manner in which a guide path 21 is arranged in the second toothed wheel half 19. Herein, apart from a stepped design of the guide, there is additionally provided a rotating path along which a first toothed wheel half, not shown in greater detail, can be guided by a portion engaging said guide path 21. Further, this view shows that the respective guides in the second toothed wheel half 19 per se can be arranged symmetrically, while only said guide path is of a different design. This depends particularly on the manner in which the individual anti-rotation systems are to be designed. In the embodiment depicted herein, it is e.g. provided that at least one end of the resilient element is on both of its sides in abutment within the guide, whereas the other end is in abutment in the second toothed wheel half within the guide at least on one side. Particularly the bent shape of the end makes it possible that one spreading portion is in abutment on a delimiting edge of the guide and the other spreading portion of the end is in abutment on an opposite area of the guide within the second toothed wheel half.

FIG. 13 is a further view of the second toothed wheel half 19 of FIG. 11 and FIG. 12. Here, it is again clearly shown that the resilient element 20 is, by its bent end, in two-sided abutment in one plane within the frame of the step-like guide, while the other bent end is in abutment only on one side. If, however, the two-sided end is displaced upward from the one, deeper plane to a plane arranged thereabove, this end will not be in two-sided abutment on respectively one face of the toothed wheel half anymore. Instead, it is now possible that at least one side of this end is engaged by a follower. Thereby, a relative movement, preferably directly between the two toothed wheel halves, can be generated from the tension produced by the resilient element 20.

FIG. 14 is an enlarged view the two-sided abutment of the bent end of the resilient element 22. Herein, it is clearly visible that the generation of tension between the two toothed wheel halves can also be enhanced by different geometries of the resilient element 20. On the other hand, it is also visible herein that the bent end can effect a fixation within the step-like guide and thus a locking engagement.

FIG. 15 in turn is a partial view of FIG. 16, the latter also included here. In FIG. 15, the other end of the resilient element 20 is shown in greater detail. This end is in abutment on only one side. At the same time, however, it can also be seen that this end is supported on the second toothed wheel half and acts as a counter support so as to guarantee the generating of tension. In principle, however, due to the step-like design of the guide in this area as shown in greater detail in FIG. 15, a displacement path can be provided along which said end would be movable. It is thus rendered possible that, in the active condition of the anti-rotation system, the divided toothed wheel is in a biased state. A still further embodiment provides that, in an active state of the anti-rotation system, the divided toothed wheel is in a non-tensioned state. Only in a non-active condition of the anti-rotation system and upon rotation into an effective position, the tensioning will occur.

FIG. 17 shows the assembled toothed wheel with the second toothed wheel half 19 in an oblique view, with the first toothed wheel half 22 nearly fully covered. Through the recesses in the second toothed wheel half 19, there can be seen respective positions of e.g. three projecting portions 23.1, 23.2 and 23.3 which are connected to the first toothed wheel half 22. In the embodiment according to FIG. 17, the toothed wheel is in a locked condition. This means that the anti-rotation system is active. In this arrangement, the first projecting portion 23.1 and the third projecting portion 23.3 cooperate with the resilient element to the effect that the toothed wheel is in a mounted condition. With the aid of the first projecting portion 23.1, the resilient element presses the first toothed wheel half 22 into this mounting position, while the projecting portion 23.3 serves as a stop and thus defines the mounting position. In the mounting position of the toothed wheel, the second projecting portion 23.2 is without an effective function.

Preferably, such an embodiment as well as other embodiments will allow for the following: In the locked position, for instance, the resilient element is supported twice on the second toothed wheel half and once on the first toothed wheel half. When, however, the resilient element is brought from its locking and thus mounting position into the play-compensating position, the resilient element is preferably supported once on the first and once on the second toothed wheel half. Thus, the resilient element will be able to allow for the relative movement between the two toothed wheel halves.

FIG. 18 shows the toothed wheel in a top view. Herein, due to the locked condition and the smaller tooth flanks of the toothing on the first toothed wheel half, the first toothed wheel half is not visible as such on the outer periphery. However, the first toothed wheel half is partly visible through the recesses in the second toothed wheel half 19. The anti-rotation system in its active state that has been achieved by the positional fixing of one of the raised portions 23, is marked by a surrounding circle. This is shown in enlarged representation in the following FIG. 19. Shown in FIG. 18 is also the third projecting portion 23.3, serving as a stop, which in the recess of the second toothed wheel half is in abutment on one end thereof by the tensioned state caused by the resilient element. If, however, the toothed wheel would be in a tooth flank play compensating function, the third projecting portion 23.3 would not be in abutment on the end of the recess but instead would be located in a position along the recess. Thus, the third projecting portion would then be without a function in this position. On the other hand, the resilient element would be in contact with the second projecting portion 23.2 and would e.g. press against it while the first projecting portion 23.1 would not be in contact with the first projecting portion 23.1 anymore. In this manner, play compensation at the flanks would be achieved.

FIG. 19 shows the encircled portion of FIG. 18. In the illustrated tensioned anti-rotation system, the first projecting portion 23.1, while being in a tensioned state, is clamped between the resilient element and the third projecting portion 23.3 of FIG. 18 serving a stop. The tension is generated by the bent end of the resilient element. Thereby, the first projecting portion 23.1 is subjected to pressure and thus is locked. Movability between the first and the second toothed wheel half is thus prevented. Herein, the bent end of the resilient element is preferably fixed, as can be seen e.g. in FIG. 14. In addition, in this embodiment, as evident from FIG. 19, the first projecting portion 23.1 and the second projecting portion 23.2 arranged at an offset the former, create a path delimitation which is realized also in the guide path 21. Said path delimitation created by both projecting portions 23.1, 23.2 respectively by one-sided abutment within a guide path 21 can delimit e.g. a circumferential relative movement. Further, it can be seen in FIG. 19 that the two projecting portions 23.1, 23.2 can e.g. have different contours. One projecting portion has a smaller diameter than the other one. In this manner, it is safeguarded that no double fit and thus possible jamming will occur during relative movement between the first and second toothed wheel halves. For the delimitation of the circumferential path, there will suffice e.g. the provided smaller projecting portion as a second projecting portion 23.2. It can also be provided, however, that both projecting portions have the same dimensions. Further, for instance, both projecting portions 23.1, 23.2 can have different lengths. Thus, by positional change of one end of the resilient element, engagement with one of the projecting portions can be rendered possible or, in another case, impossible.

FIG. 20 shows a further toothed wheel 24 in exploded view. As a resilient element 22, there is again provided a torsional spring. This torsional spring is arranged between the first toothed wheel half 26 and the second toothed wheel half 27. Additionally provided is a displaceable locking component 28 formed e.g. as a locking pin. This locking component 28 is e.g. adapted to be displaced in an axially parallel manner relative to an axis of rotation of the toothed wheel 24. Preferably, the locking component 28 has a first end position and a second end position opposite thereto. While, in the first end position, a mutual securement of the two toothed wheel halves is performed, the second end position allows for relative rotation of the toothings of the toothed wheel halves relative to each other. The tensioning required therefor is achieved by the resilient element 25 which is correspondingly coupled to the first and respectively second toothed wheel half 26,27. Coupling to the first toothed wheel half 26 is effected by the first end 29 which is inserted into an opening 30. The second end 31, however, is inserted into a corresponding fitting recess 32 and cannot move therein. The first end 29, however, can be laterally moved along a guide 33 within the second toothed wheel half 27 up to the stop. This stop will e.g. define the movability of the first and second toothed wheel halves relative to each other.

FIG. 21 is a sectional view of the toothed wheel 24 of FIG. 20 in the assembled state. The first toothed wheel half 26 and the second toothed wheel half 27 are locked to each other by means of the locking component 28. The Figure illustrates the manner in which the locking component 28 is one the one hand seated in the first toothed wheel half 26 while, on the other hand, engaging into a corresponding guide of the second toothed wheel half 27. Thus, in spite of the tensioning forces applied by the resilient element 25, the two toothed wheel halves 26,27 cannot rotate relative to each other. In the Figure, the locking component 28 is shown without a delimiting path toward the outside. Preferably, however, the locking component 28 is inserted into the first toothed wheel half 26 at least by press fit. Thereby, it is avoided that the locking component 28 might accidentally fall out of the toothed wheel 24, e.g. during the assembly process. For instance, it can be provided for this purpose that a clearance fit exists in the first toothed wheel half 26 and a press fit exists in the second toothed wheel half 27. In this case, by means of the press fit in the second toothed wheel half 27, the locking component 28 is prevented from falling out. It can also be provided that the first toothed wheel half 26 comprises such an opening of a type which is itself effective to prevent the locking component from falling out, e.g. in that the locking component is correspondingly covered by a one of the surfaces of the first toothed wheel half 26. This is comparable to the covering of the resilient element 25 which, as illustrated, is for the most part exclusively arranged in a corresponding recess within the second toothed wheel half 27.

FIG. 22 shows a further sectional view of the toothed wheel from FIG. 20 according to a further embodiment. Herein, the toothed wheel 24 is provided with a non-active anti-rotation system. In this arrangement, the locking component 28 is pressed into place in a second position, notably into the second toothed wheel half 27. Thereby, the locking of the first toothed wheel half 26 and of the second toothed wheel half 27 is released. Both toothed wheel halves can rotate relative to each other. That this has occurred can be seen from the interrupted lines of the tooth flanks of the first and second toothed wheel halves in comparison to those from FIG. 21. The locking component 28 is now secured and cannot move axially out of its position unless it would be pulled out of this position again by means of a tool. For this purpose, e.g. by use of a pulling or pressing tool acting on the locking component 28 from the outside, the locking component 28 can again brought into a position causing the two toothed wheel halves 26,27 to be locked.

FIG. 23 shows an exemplary embodiment of the locking component 28 of FIGS. 20 to 22. On the one hand, locking component 28 comprises, e.g. on one end, a chamfer which will facilitate an insertion from the first toothed wheel half into the second toothed wheel half. On the other hand, for instance, the diameter of locking component 28 is such that an undesired breaking-apart due to the dimensions of the locking component 28 cannot occur. Further, e.g. on the other end of locking component 28, there is advantageously provided a widening with a chamfer. This allows for a press-in movement into the second toothed wheel half. In this manner, for instance, there can also be used a design wherein the first as well as the second toothed wheel half each comprise a clearance fit and the press fit is generated exclusively by the locking component 28. However, apart from this exemplary embodiment of the locking component 28, use can be made also of other designs for effecting the locking of the two toothed wheel halves. Apart from the use of one locking component 28, it is also possible to provide a plurality of such locking components.

As evident from the various embodiments described above, the flank contour, the tooth base diameter and the tooth tip diameter of the first and second toothed wheel halves are at least approximately identical but can also adapted in a different manner, if required. In each of the illustrated embodiments, the first toothed wheel half has a smaller thickness than the second toothed wheel half, particularly in the area of the toothing. For this reason, it is preferred to use the first toothed wheel half as that component of the toothed wheel which will compensate for the tooth flank play of the mutually meshing toothed wheels. In this case, the first toothed wheel half will also transmit a smaller moment than the second toothed wheel half. Preferably, for this purpose, the first toothed wheel half has a reduced tooth shape in comparison to the second toothed wheel half. Thereby, it is accomplished that a fatigue strength behavior of both toothed wheel halves is preferably approximately identical. However, it can also be provided that the second, thicker toothed wheel half will compensate for the tooth flank play. According to a further embodiment, for instance, it is provided that two toothed wheels mesh with each other, wherein both toothed wheels are divided toothed wheels. Preferably, both toothed wheels are designed as described above. However, it can also be provided that only one of the two divided toothed wheels is of a design as described above. Preferably, both divided toothed wheels each comprise a thinner first toothed wheel half which will compensate for the flank play. Further, it is preferred if each thinner first toothed wheel half will interact—i.e. be in contact—with the thicker second toothed wheel half of the other meshing toothed wheel. Thereby, for instance, the tooth flank play to be compensated will be distributed onto both toothed wheels. Preferably, this is provided in meshing toothed wheels which have a larger width.

Further, the proposed toothed wheel can have a helical toothing, double helical toothing or herringbone toothing as well as a straight toothing. The toothed wheel can be a spur gear while, however, the principle can also be used in a toothed rack. However, the toothed wheel can also be an ellipsoidal wheel, a conical wheel, a crown wheel, a worm gear or another moving, particularly rotating object provided with a toothing wherein a force is transmitted via said toothing. The toothing can also comprise an inner toothing so that the toothed wheel comprises an inner toothing. The toothed wheel is preferably useful in gear transmissions of a large variety of designs, e.g. in rolling contact gears or worm gears, particularly also in a large variety of planetary gears, and in hand-operated and automatically operated gear shafts.

1. A toothed wheel having a compensating function for compensating, by use of a divided toothing, tooth flank play in a meshing engagement with a second toothed wheel, said toothed wheel having at least one split along which a first toothed wheel half comprising a first section of the divided toothing and a second toothed wheel half comprising a second section of the divided toothing are arranged so as to be able to rotate relative to one another, the toothed wheel halves being provided to be arrested relative to one another by means of an anti-rotation system which, when activated, prevents mutual rotation of the toothed wheel halves, wherein, when said anti-rotation system is activated, the first and the second section of the divided toothing are arranged relative to each other in an at least approximately flush manner whereas, when the anti-rotation system is not activated, said first and said second section of the divided toothing are arranged to be offset to one another, both sections being tensioned relative to one another by means of a resilient element, and the inactive anti-rotation system remaining in the toothed wheel while said toothed wheel is in operation.

2. The toothed wheel according to claim 1, wherein the anti-rotation system can be released without being destroyed.

3. The toothed wheel according to claim 1, wherein the anti-rotation system can be activated repeatedly.

4. The toothed wheel according to claim 1, wherein the anti-rotation system is a component arranged within the toothed wheel, which in a first position blocks a rotary movement and in a second position allows for a rotary movement, said component being under tension at least in the second position.

5. The toothed wheel according to claim 1, wherein the anti-rotation system and the resilient element are formed as one component.

6. The toothed wheel according to claim 1, wherein, for use as a resilient element, a leg spring is arranged in the toothed wheel, said leg spring serving as an anti-rotation system and as a component tensioning the two toothed wheel halves relative to each other.

7. The toothed wheel according to claim 1, wherein the first and second toothed wheel halves comprise respective guides adapted to be brought into mutual congruence, said guides having arranged in them a movable locking component acting as an anti-rotation system.

8. The toothed wheel according to claim 1, wherein the first and second toothed wheel halves comprise respective guides adapted to be brought into mutual congruence and that the anti-rotation system comprises an angled arm adapted to be inserted into both guides simultaneously and thereby to activate the anti-rotation system.

9. The toothed wheel according to claim 1, wherein the anti-rotation system comprises a displaceable locking pin.

10. A method for installation of a divided toothed wheel preferably according to claim 1, wherein, for installation, a first and a second toothed wheel half of the divided toothed wheel having respective sections of a divided toothing are locked in a manner preventing relative rotation, and wherein, after installation, a locking arrangement of the two toothed wheel halves is released and the two toothed wheel halves are left in a state of tension toward each other while being movable and, after release of the locking arrangement, a component effecting the locked state is left to remain in the toothed wheel.

11. Installation according to claim 10, characterized in that wherein the interior of the toothed wheel is accessed from the outside and said component effecting the locked state is displaced, thereby releasing the locking arrangement.
